(19) United States
(12) Patent Application Publication
(10) Pub. No.: US 2019/0047653 A1
(43) Pub. Date: Feb. 14, 2019

(54) DEPLOYABLE FOOT PLATFORM PERSONAL TRANSPORTATION DEVICE

(71) Applicant: Shane Chen, Camas, WA (US)

(72) Inventor: Shane Chen, Camas, WA (US)

(21) Appl. No.: 15/675,702

(22) Filed: Aug. 12, 2017

(51) Int. Cl. B62K 11/00; B60C 23/00; B62K 1/00

(52) U.S. Cl. CPC B62K 11/007; B62K 2015/003; B62K 1/00; B60C 23/001

(57) ABSTRACT

An ergonomic and rider-friendly auto-balancing personal transportation device. The device may have a central wheel structure with one or more tires and deployable foot platforms located on both sides of the central wheel structure. The platforms may be linked to a handle, such that lifting the handle retracts the foot platforms and releasing the handle may deploy them. The tire size and platform size may be set so that the device is easy to step on to, and the distance to ground when dismounting is reduced. Dual tire and single wider tire embodiments are disclosed as are other features and embodiments.

### CROSS REFERENCE TO RELATED APPLICATIONS

The present application claims the benefit of provisional application No. 62/373,967, filed Aug. 11, 2016, for a Ergonomic, Central-Wheel Structure Self-Balancing Device by the inventor herein.

### FIELD OF THE INVENTION

The present invention relates to personal transportation devices and, more specifically, to deployable foot platforms is such devices. The present invention also relates to compact light-weight design, equalized air pressure, enhanced stability, and other features in such devices.

### BACKGROUND OF THE INVENTION

The prior art includes self-balancing personal transportation devices. One is the Segway, described in U.S. Pat. No. 6,302,230 for Personal Mobility Vehicles and Methods, issued to Kamen et al., and another is the Solowheel, described in U.S. Pat. No. 8,807,250 for a Powered Single-Wheeled Self-Balancing Vehicle for Standing Use (the '250 patent), issued to Shane Chen, the inventor herein. The '250 patent is hereby incorporated by reference as though disclosed in its entirety herein.

While devices such as those disclosed in the '250 patent are an advancement in the art of transportation devices, they may have disadvantages aspects. One is that they are relatively bulky and heavy, making them somewhat unattractive and difficult to carry or stow, for example, if used in commuting where a person must carrying or stow the device when not in use, i.e., on a bus or train, or in the office. Thus, a need exists for a lighter-weight and/or better form factor device.

Furthermore, larger devices may be more intimidating to a new user, effectively creating a bar to use. A need exists for a lower profile device that is easier to step on or off of and that has a sleeker, less intimidating appearance. A more stable device is also sought.

A need also exists for ready retraction and deployment of foot platforms, including retraction and deployment that occur automatically or near automatically when a user picks up or sets down the device.

In addition, for embodiments having two paired wheels or a single tire structure with two tires, a need exists for pressure equalization between the tires. This would improve shock absorption, steering, turn efficiency, and stability.

### SUMMARY OF THE INVENTION

Accordingly, it is an object of the present invention to provide a personal transportation device that overcomes the shortcomings of the prior art and meets the unmet needs.

It is also an object of the present invention to provide a personal transportation device with ready deployment and retraction of the foot platforms, either through a linkage mechanism or another mechanism.

It is another object of the present invention to provide a personal transportation device that has a “user-friendly” appearance and configuration so that it appears inviting and non-intimidating and is in fact easy to use, particularly for first-time and newer riders.

It is yet another object of the present invention to provide a personal transportation device that has a dual tire structure with air pressure equalization.

These and related objects of the present invention are achieved by use of personal transportation device as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-6 illustrate one embodiment of a self-balancing personal transportation device in accordance with the present invention.

FIGS. 7-12 illustrate another embodiment of a self-balancing personal transportation device in accordance with the present invention.

FIG. 13 is an elevation view illustrating a wider tire.

FIG. 14 is an elevation view illustrating the potential height of folded platform sections relative to tires.

FIGS. 15-16 are perspective views of yet another embodiment of a self-balancing personal transportation device in accordance with the present invention.

FIG. 17 illustrates the device of FIG. 15-16 yet with a wider tire.

### DETAILED DESCRIPTION

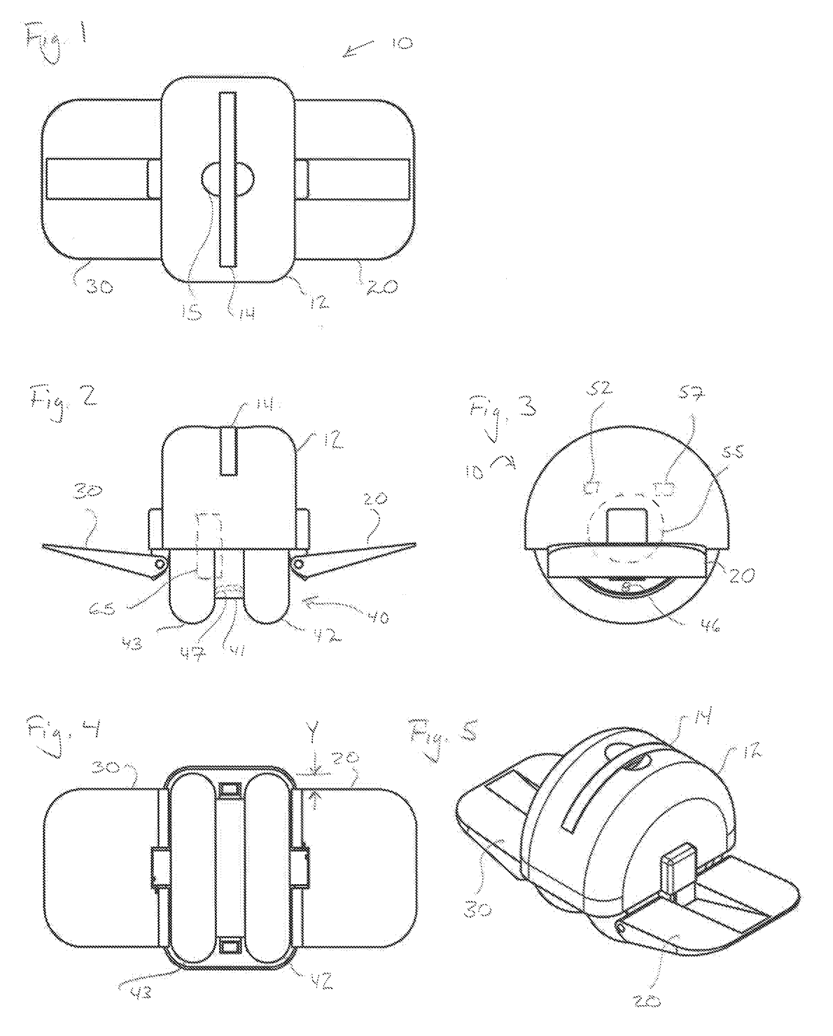

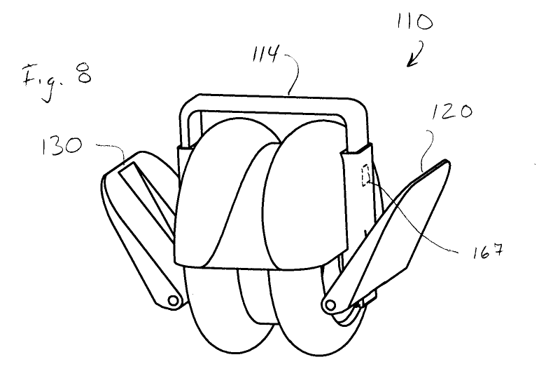

Referring to FIGS. 1-6, one embodiment of a self-balancing personal transportation device 10 in accordance with the present invention is shown. Device 10 operates similar to the self-balancing device(s) of the '250 patent referenced above, particularly with respect to propulsion, speed and direction of travel.

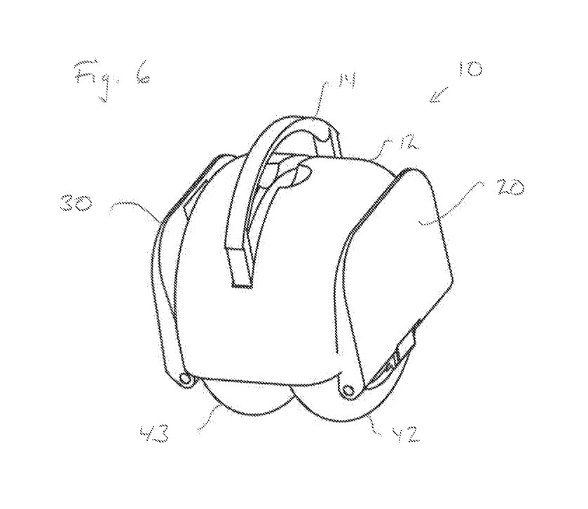

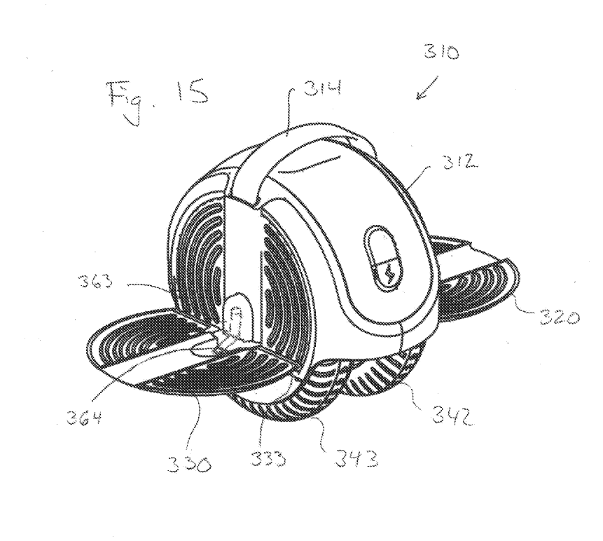

Device 10 may include two tires 42,43 mounted on a rim 41 (FIG. 2). This may be referred to as a “single wheel structure.” In the embodiments of FIGS. 13 and 17 below, a single tire may be provided on a rim, and this may also be referred to as a “single wheel structure.” The term “single wheel structure” as used herein refers to one or more tires mounted to a single rim, or to multiple rims that are coupled together so as to move at the same speed and direction.

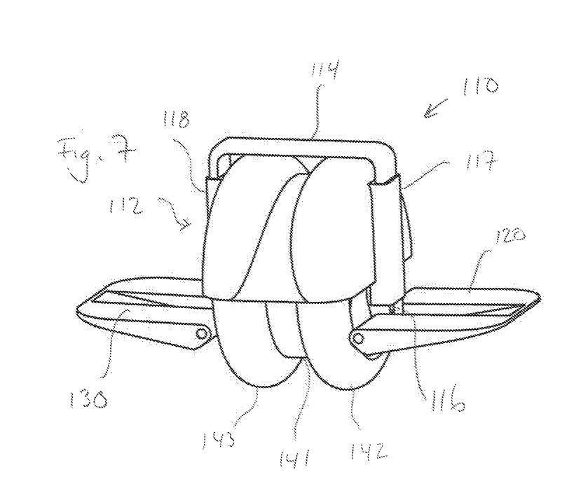

As shown in phantom lines in FIG. 3, a gyroscopic position sensor 52, electronic control circuit 57 and a hub motor 55 are preferably provided. The position sensor may sense fore-aft position and the control circuit preferably drives hub motor 55 (which in turn drives rim 41) towards fore-aft balancing of the device based on the sensed fore-aft position. Sensor 52 may also sense side-to-side (or lateral) tilt. Control circuit 57 may adjust speed or other parameters based on a sensed sideways tilt, for example, slowing the device during a turn. Electronic control for a self-balancing single wheel structure vehicle is known in the art.

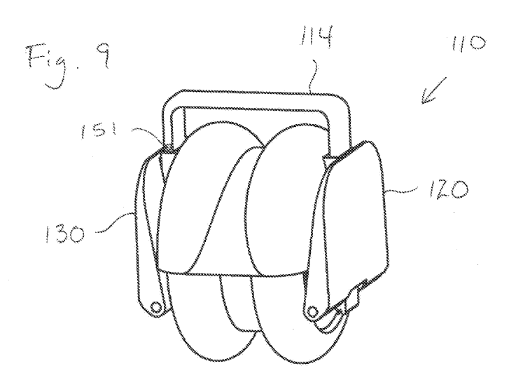

Device 10 may have two foot platforms 20,30. These are preferably mounted to a frame or housing 12 in such a manner that they may be moved between a deployed or in-use position and a folded or stowed position. In FIGS. 1-5, they are shown in the in-use or deployed position and, in FIG. 6, they are shown in the stowed position.

A transport handle 14 may be provided and, in the embodiment of FIGS. 1-6, may nest within housing 12 when not in use. A finger depression 11 may facilitate extraction of the handle from the nested position.

FIG. 3 illustrates a tire fill valve 46, while FIG. 2 illustrates a conduit 47 through rim 41 that provides air passage between the tires. The tires preferably mount to rim 41 in an air tight manner and air pressure between the tires is equalized through conduit 47. In addition, or alternatively, an exterior conduit may be provided including one that couples to the fill valve of each tire.

The dual tire arrangement increases lateral stability over the devices of the '250 patent (regardless if air pressure is equalized or not).

Tires 42,43 are preferably round in lateral cross-section (for example, as shown in FIGS. 2 and 4) as compared to square-cornered tractor-trailer tires. The rounded shape allows a user to turn the device by leaning sideways (decreasing the effective radius).

Turning and stability are further enhanced with pressure equalization. For example, when a user leans laterally, the weight on one tire increases over that of the other. In a device without air pressure equalization, if a riders leans a sufficient amount, then the less weighted tire may lift off the ground. This creates a less stable riding condition than if both tires remain in contact with the ground. A benefit of air pressure equalization is that as weight increases on one tire due to a lean, air is pushed out of that tire toward the less weighted one. This reduces the radius of the more weighted tire and increases the radius of the other tire, resulting in both tires remaining in contact with the ground for a longer time period.

Furthermore, if one tire has a smaller effective radius, then the device will turn towards the side with the smaller radius, thereby increasing the turning ability or effectiveness of the device.

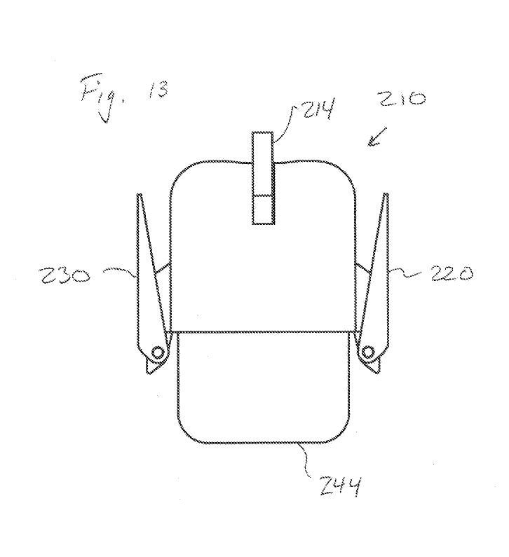

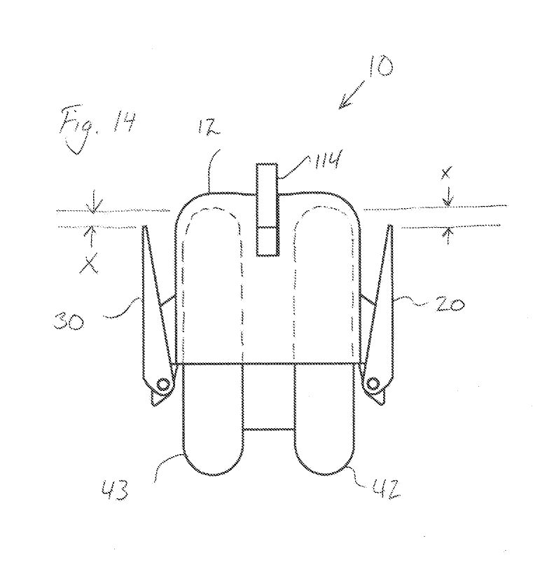

Referring to FIGS. 7-12, another embodiment of a self-balancing personal transportation device 110 in accordance with the present invention is shown. With respect to propulsion and turning, device 110 functions in a similar manner (and has the same or similar components) as device 10 described above. Device 110 has a handle 114 with two ends 113,115. A first cable 116 is coupled between end 113 and foot platform 120 and another cable 119 is coupled between end 115 and foot platform 130 (cable 119 is obscured from view in the perspective of FIG. 7, yet visible in FIG. 12). Ends 113,115 of handle 114 are configured to fit slidably into sheathes 117,110. FIG. 12 illustrates device 110 with the sheathes and housing removed. Cables 116,119 are visible.

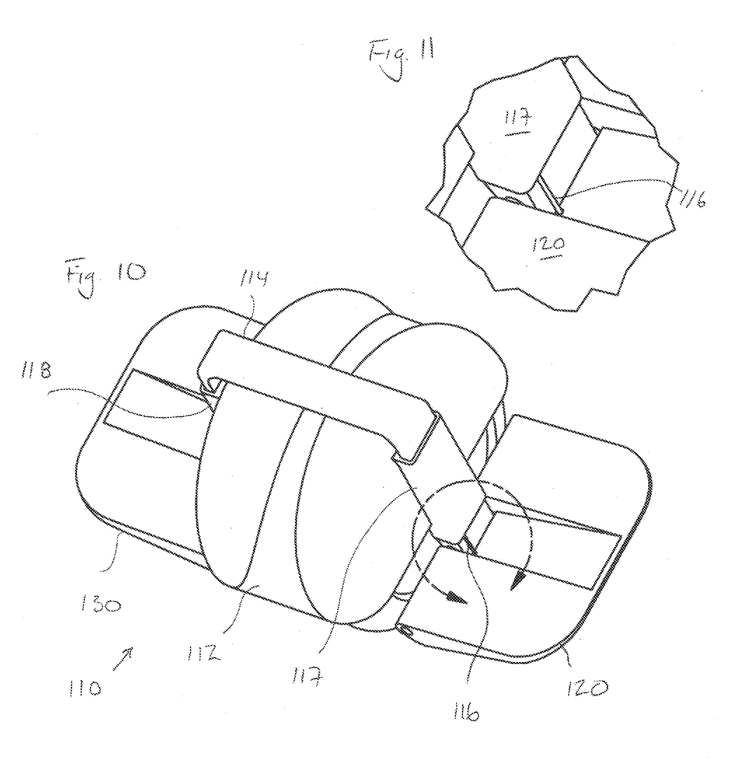

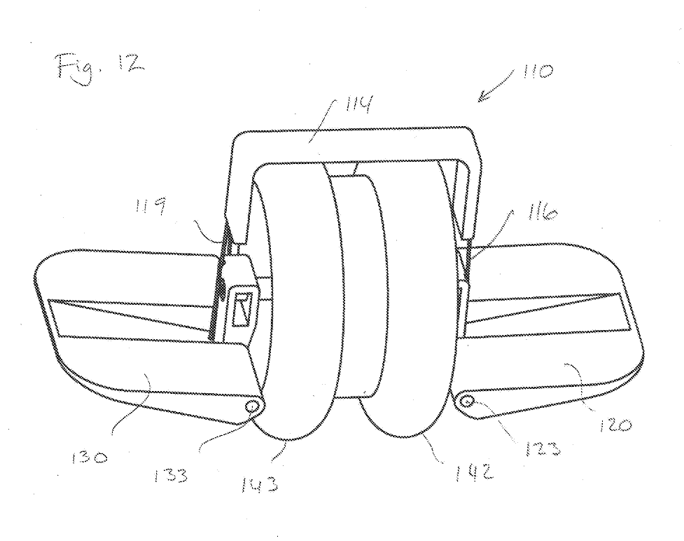

FIGS. 7, 10 and 12 illustrate device 110 with handle 114 fully let down and platforms 120,130 fully deployed. FIG. 9 illustrates handle 14 fully raised and foot platforms 120,130 fully retracted. FIG. 8 illustrates the handle partially raised and the foot platforms partially retracted.

The foot platforms 120,130 are preferably pivotally attached and the cables located an appropriate distance from their pivot axis 123,133 that a relatively short travel distance of the cable yields sufficient movement of each foot platform to move that platform from the extended to the retracted position.

Note that a mechanism such as a releasable latch or magnet or electro-mechanical actuator or other mechanism may be used to latch or lock the platforms in this retracted position. FIG. 8 illustrates a magnet 167 that would attract a piece of magnetic material on foot platform 120. Similar magnetic components could be used for platform 130. If a magnet or latch or cam-based mechanism or the like is provided, then the platforms could be retained in the closed position and handle 114 nested into the housing for very compact stowage configuration, good for stowing under a bus seat or in or under desk at work or the like.

In addition, handle 114 may be locked or latched in the carry or platforms retracted position. For example, FIG. 9 illustrates a spring biased pin 151 that extends outwardly above sheath 118. This may retain handle 111 in the raised position and thereby hold the foot platforms in the retracted position. A user pushes against the bias force of the pin while pushing down on the handle to “sink” the handle into the sheathes, thereby deploying the platforms.

Referring to FIG. 13, yet another embodiment of an self-balancing personal transportation device 210 in accordance with the present invention is shown. Device 210 is similar to device 10 of FIGS. 1-6, yet instead of having two individual tires mounted to a single rim structure, device 210 has only one tire 244, albeit a wide or laterally spread tire. The width of tire 244 provides some of the balance features provided by two parallel tires (42,43) and some of the control provided by tire pressure equalization discussed above. The wide tire 244 may experience more friction with the riding surface then narrow tire(s), resulting in increased drag, fastor power consumption, and less ride time between recharge (depending on speed, riding surface, and other variables).

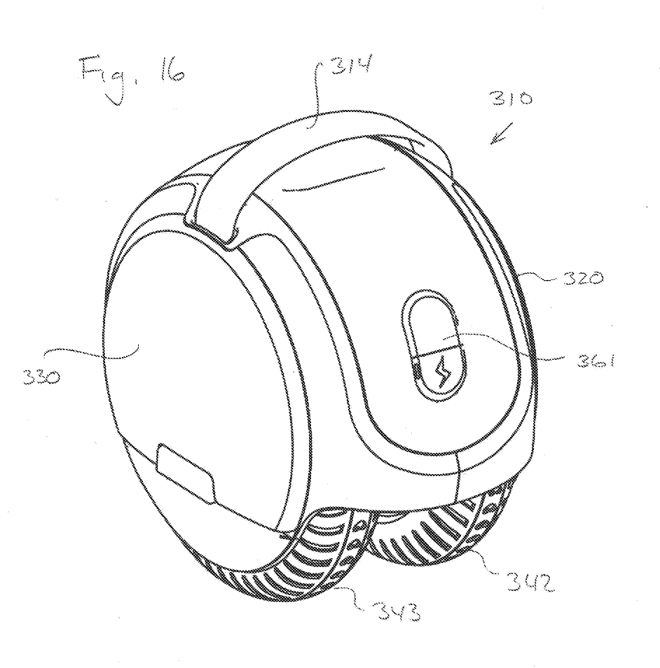

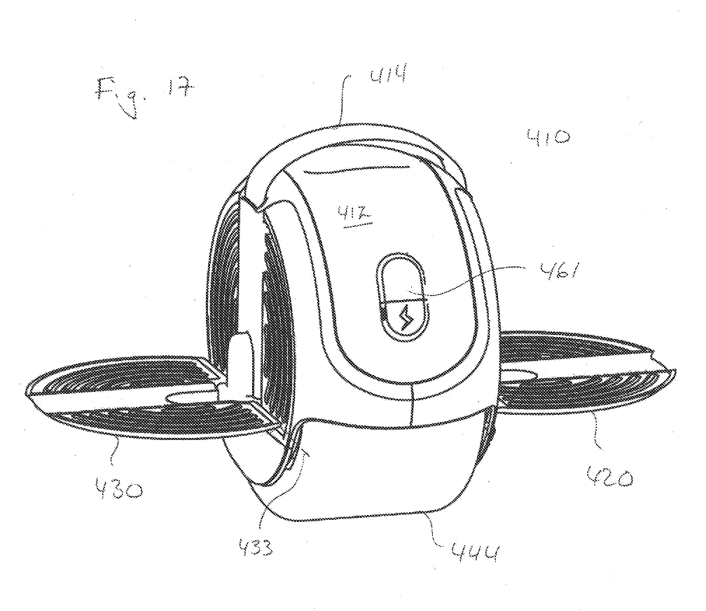

Referring to FIGS. 15-16, perspective views of another embodiment of self-balancing personal transportation device 310 in accordance with the present invention is shown. Device 310 may operate in a manner similar to other transportation devices discussed herein, particularly with respect to propulsion and turning, etc. Device 310 may include foot platforms 320,330, two tires 342,343 (which may be on a single rim or single rim structure), handle 314 and housing 312.

The foot platforms are pivotally coupled, axis 333 for platform 330 is visible in FIG. 15. FIG. 15 illustrates platforms 320,330 in the extended or deployed position while FIG. 16 illustrates them in the retracted or stowage position.

FIG. 15 illustrates electro-mechanical actuators 363 and coupling arm or member 364. Actuator 363 may include a motor that in turn moves arm 364 so that it moves platform 330 between the extended and the retracted position. A similar actuator and arm/member may be provided for platform 320. In addition, other actuator mechanisms may be used, including rotary or axial actuators that provided about axis 333 (and a similar axis for platform 320) to move the platform between open and closed.

The control circuit may be configured so that a double push or sustained duration push on button 361 initiates the retraction of deployed platforms and vice versa. A magnet or latch or the like 367 may be provided as discussed above for device 110.

FIG. 15 illustrates that the platforms may approximate the shape of the housing 312 or the tires 342,343, at least in part. Above the axis, platform 330 may be curved with an arc that is substantially concentric with an analogous arc of the tires. As shown, the pivot axis of the platforms may be below the axis of rotation of tires 342,343.

Without departing from the present invention, the platforms may have a principal arc (i.e., the main arc segment) that is not concentric with the axis of rotation of the tires, having, for example, a center that is below or otherwise positioned with respect to the tire axis of rotation. Similarly, the platforms may have a principal arc that has a radius that is 0-25% of the radius of the tire, or more preferably between 0-15% or 0-10% or other.

With respect to surface area of the platform relative to the surface area of the vertical plane of a tire (342 or 343), the platform may have a surface area that is 25% of the surface area of the tire. This platform surface area may be 10 to 20 or 25% of the tire vertical plane surface area or be a larger about. The platform may have a surface area from 25-35% of the tire plane surface area or 35-50% or more than 50%, for example from 50% or 60% or more (i.e., 60-70% or 70-80% or other), as discussed below.

For example, if the tire has a radius of 4″ (an 8″ outer diameter), and the arc of the foot platform has a radius 3.5″ (7″ long), then the wheel has a vertical plane area of 50.27 or near 50 sq. in. The area of a 3.5″ circle is 38.48 and half of that is near 20 sq. in. Since the axis 333 is below the rotation axis of the wheel, the platform may have a surface area of approximately 28-32 sq. in., or 30 sq. in. Thus, the platform a surface area of 30 sq. in is 60% of the vertical plane surface area of the tire, 50 sq. in.

If the platform is 6″ long than the foot platform may have an area approximately 50% of the area of the tire's vertical plane, 25 sq. in. compared to 50 sq. in. If, however, the platform is 6″ long and the tire 10″ in diameter, then the surface area of the foot platform is approximately 30% of the vertical plane area. Further, for a 7″ long platform and a 12″ tire the platform surface area may be approximately 25% of the vertical plane area of the tire, depending on the configuration of the tire.

FIG. 17 illustrates device 410 that is similar to device 310 of FIGS. 15-16, yet has a single wide tire 444.

Other features of the embodiments of FIGS. 15-17 include that the foot platforms have their greatest width proximate that handle and wheel axle or, in other words, near their center.

In at least one embodiment of the present invention, the tires are smaller than the tire of a standard Solowheel (e.g., a device of the the '250 patent).

FIG. 4 shown that the length of the foot platforms is nearly as long as the tire outer diameter, the platform length being 2Y less than the outer diameter of the tire. The length of the foot platforms 20,30 may actually be longer than the diameter of the tire(s), for example, by 1 to 5% or even more, such as form 6-10%, or 11-15% or 16-20% or more.

Conversely, the length of foot platform 20 may be 1-5% less than the diameter of tire 41, or 6-10%, or 11-15% or 16-20% less than the diameter of tire 41, or even a further percentage less of that diameter. In one embodiment, the tires 20,30 may have an outer diameter of 8″ and the platforms are 7″ long (longitudinally, i.e., in the direction of travel of the device).

Referring to FIG. 14, it can be seen that the folded platforms nearly reach the same height as their associated tires, X being the difference. It should be noted that the platforms may be taller or shorter than their associated tires by the same range of percentage given above for the length of each platform relative to its tire.

With respect to other components, the battery 65 may be a lithium ion or other suitable battery. Suitable gyroscopic position sensors are known in the art. The device may be made of any suitable materials known for use in self-balancing vehicles.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A central wheel structure self-balancing transportation device, having one or more of the following:
a dual tire structure with pressure equalization;
linkage between a handle and foot platforms such that movement of the handle can achieve movement of the foot platforms; and
a compact ergonomic design.
